(19) United States
(12) Patent Application Publication
(10) Pub. No.: US 2008/0003846 A1
(43) Pub. Date: Jan. 3, 2008

(54) Circuit board unit

(75) Inventor: Shigenori Miyagawa, Tokyo (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/715,151

(22) Filed: Mar. 6, 2007

(30) Foreign Application Priority Data
Jun. 29, 2006 (JP) P2006-179249

(51) Int. Cl. H01R 12/02

(52) U.S. Cl. 439/71

(57) ABSTRACT

According to one embodiment, a circuit board unit includes: a circuit board; and an electronic component that is surface-mounted on the circuit board. The electronic component includes a first electrode at one end and a second electrode at another end of the electronic component. The circuit board includes a plurality of penetrating holes penetrating through the circuit board at a position close to the first electrode and at a position close to the second electrode. The penetrating holes are arranged substantially symmetrically with respect to the electronic component.

### CROSS-REFERENCE TO RELATED APPLICATIONS

This application is based upon and claims the benefit of priority from Japanese Patent Application No. 2006-179249, filed Jun. 29, 2006, the entire contents of which are incorporated herein by reference.

### BACKGROUND

1. Field

One embodiment of the invention relates to a circuit board unit and more particularly to a circuit board unit for mounting an electronic component such as a ceramic capacitor.

2. Description of the Related Art

In recent years, a ceramic capacitor is commonly used also in a power circuit requiring a capacitor having a comparatively large capacity. This is because a development of a thin coating material having a high dielectric constant has proceeded and the needs of a reduction in a size and an increase in a density of an electronic apparatus have been increased.

In the ceramic capacitor, a ferroelectric substance is used as a dielectric material. Therefore, an oscillation is generated by a piezoelectric phenomenon when an AC voltage as well as a DC voltage is applied to the ceramic capacitor. The oscillation appears more remarkably when the ceramic capacitor has a greater dielectric constant or a larger size.

When the oscillation is generated on the ceramic capacitor, the oscillation is transmitted to a mounting board of the ceramic capacitor and the board resonates so that a resonance sound is amplified. In these cases, surrounding air of the board is vibrated by the oscillation of the capacitor so that a sound is generated. Furthermore, the board resonates so that a sound pressure is raised, resulting in an audible harsh sound.

As a solution of the problem, for example, Japanese Patent Application Publication (KOKAI) No. 2000-182888 discloses a configuration in which a metal plate is provided on the outside of electrodes at both ends of the ceramic capacitor of a surface mount type and the metal plate and the electrodes are bonded by soldering. In the ceramic capacitor having this configuration, a clearance is formed between the metal plate and the mounting board. Even if the piezoelectric phenomenon is generated over the ceramic capacitor, an oscillation of the ceramic capacitor is not directly transmitted to the mounting board. As a result, it is possible to reduce the resonance sound.

In the ceramic capacitor having the configuration disclosed in the Japanese Patent Application Publication (KOKAI) No. 2000-182888, however, it is necessary to bond the metal plate to the electrodes by soldering. Therefore, the number of processing steps increases to cause a cost increase of the components.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are exemplary views showing configuration of a circuit board unit according to a first embodiment of the invention;

FIGS. 2A and 2B are exemplary views for conceptually explaining the function of a penetrating hole according to each embodiment of the invention;

FIGS. 3A and 3B are exemplary views showing a configuration of a circuit board unit according to a second embodiment of the invention;

FIG. 4 is an exemplary view showing a configuration of a circuit board unit according to a third embodiment of the invention;

FIG. 5 is an exemplary view showing a configuration of a circuit board unit according to a fourth embodiment of the invention;

FIG. 6 is an exemplary view showing a configuration of a circuit board unit according to a fifth embodiment of the invention; and

FIG. 7 is an exemplary view showing a configuration of a circuit board unit according to a sixth embodiment of the invention.

### DETAILED DESCRIPTION

Various embodiments according to the invention will be described hereinafter with reference to the accompanying drawings. In general, according to one embodiment of the invention, three is provided a circuit board unit including: circuit board; and an electronic component that is surface-mounted on the circuit board. The electronic component includes a first electrode at one end and a second electrode at another end of the electronic component. The circuit board includes a plurality of penetrating holes penetrating through the circuit board at a position close to the first electrode and at a position close to the second electrode. The penetrating holes are arranged substantially symmetrically with respect to the electronic component.

### First Embodiment

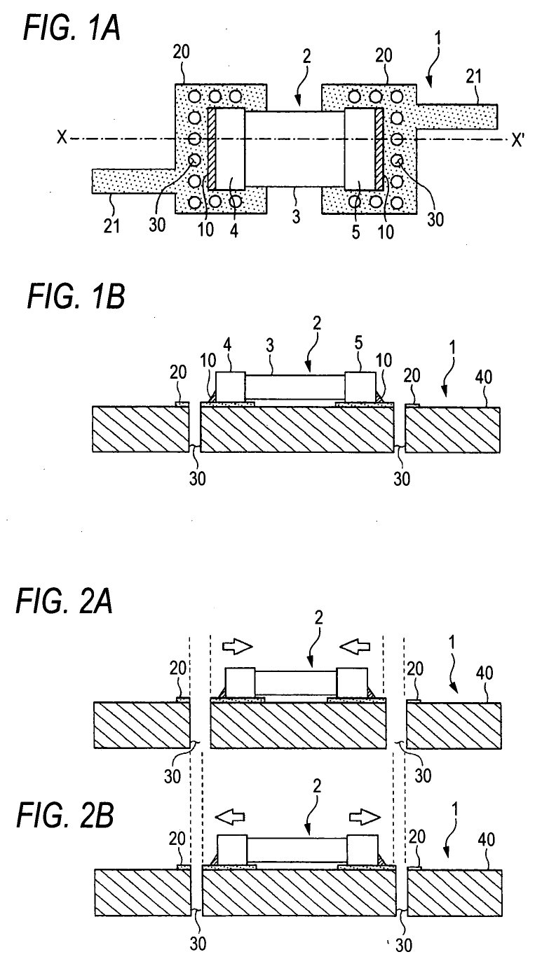

FIGS. 1A and 1B are exemplary views showing a configuration of a circuit board unit 1 according to a first embodiment. FIG. 1A is a plan view showing the circuit board unit 1 and FIG. 1B is a sectional view taken along X-X′ in the circuit board unit 1.

The circuit board unit 1 includes a board and an electronic component mounted on the board. The board includes an insulating plate 40 and a surface conductor formed on a surface of the insulating plate 40 by etching. As illustrated in FIG. 1, the surface conductor includes a pad 20 on which an electrode of the electronic component is mounted and a connecting pattern 21 for electrically connecting another pad and a connector (not shown).

Specifically, an electronic component such as a ceramic capacitor 2 is mounted on the board of the circuit board unit 1.

The ceramic capacitor 2 is a surface mount type device and includes a capacitor body 3, and a first electrode 4 and a second electrode 5 which are provided on both ends thereof. The first electrode 4 and the second electrode 5 are soldered to the pad 20 by a solder 10, respectively.

A plurality of penetrating holes are formed close to the first electrode 4 and the second electrode 5. In the first embodiment as shown in FIGS. 1A and 1B, a plurality of penetrating holes 30 having a substantially circular shape is formed and arranged in a U-shape in order to surround each of the first electrode 4 and the second electrode 5. Also, the penetrating holes 30 are arranged substantially symmetrically with respect to the ceramic capacitor 2.

In FIG. 1, each penetrating hole 30 penetrates through both the pad 20 and the insulating plate 40. When an area of the pad 20 is substantially equal to areas of the first electrode 4 and the second electrode 5, respectively, it is possible to form each penetrating hole 30 close to the first and second electrodes 4 and 5 without penetrating through the pad 20. In this case, it may be preferable to penetrate through only the insulating plate 40.

FIGS. 2A and 2B are exemplary views for conceptually explaining the function of the penetrating hole 30. In the case where the electronic component to be mounted on the circuit board unit 1 is a component generating the piezoelectric phenomenon such as the ceramic capacitor 2, an oscillation is generated when an alternating current is applied to the ceramic capacitor 2. Particularly, when the oscillation is transmitted to the insulating plate 40 to cause a resonance, a comparatively great resonance sound is generated.

In the circuit board unit 1 according to the embodiment, the penetrating hole 30 is formed. Consequently, the oscillation generated by the ceramic capacitor 2 is absorbed into the penetrating hole 30 so that the transmission of the oscillation to the insulating plate 40 is reduced.

FIGS. 2A and 2B exaggeratedly illustrate states of the oscillation. The oscillation of the ceramic capacitor 2 is generated by the repetition of a contraction and extension caused by the piezoelectric phenomenon at a frequency of the applied alternating current.

The penetrating holes 30 are formed close to the first and second electrodes 4 and 5. Consequently, a diameter of the penetrating hole 30 is increased when the ceramic capacitor 2 contracts as shown in FIG. 2A. On the other hand, the diameter of the penetrating hole 30 is reduced when the ceramic capacitor 2 extends as shown in FIG. 2B.

As a result, the oscillation of the ceramic capacitor 2 remains in a region to which the ceramic capacitor 2 is fixed, and the transmission of the oscillation to an external region is attenuated. More specifically, the resonance of the insulating plate 40 is reduced and the resonance sound which has conventionally been generated is also reduced.

As described above, the penetrating hole 30 is formed in order to reduce the resonance sound of the electronic component to be oscillated, for example, the ceramic capacitor 2. Therefore, the penetrating hole 30 is unnecessary to be formed around the electronic component not to be oscillated. When the ceramic capacitor is provided in a high frequency circuit, an oscillation frequency may be so high that the oscillation does not cause particular troubles. In this case, it is not always necessary to form penetrating hole 30.

### Second Embodiment

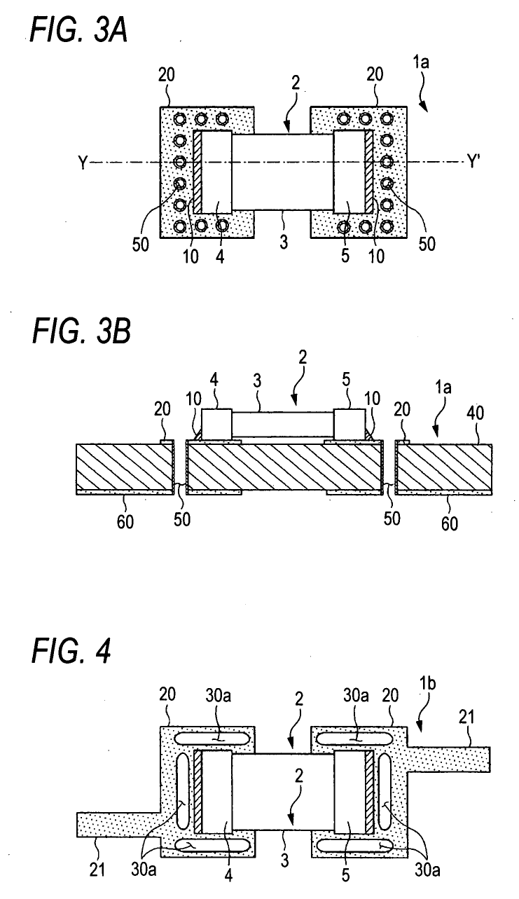

FIGS. 3A and 3B are exemplary views showing a configuration of a circuit board unit 1a according to a second embodiment. FIG. 3A is a plan view showing the circuit board unit 1a and FIG. 3B is a sectional view taken along Y-Y′ in the circuit board unit 1a. The first and second embodiments are different from each other in that the penetrating hole 30 is replaced with a through hole 50.

Recently, the circuit board unit 1a is subjected to high density mounting and a multilayer board is often used. Therefore, there is often used the through hole 50 for transferring a signal or a power of a component provided on a surface of the board to another layer.

The through hole 50 penetrates through the insulating plate 40 and an inside of the through hole 50 is plated with copper etc. to have conductivity. The through hole 50 electrically connects one conductive layer to another conductive layer.

In the example shown in FIGS. 3A and 3B, a pad 20 mounting a ceramic capacitor 2 thereon and a conductor pattern 60 provided on a back layer of the insulating plate 40 are electrically connected to each other via the through hole 50.

Although FIGS. 3A and 3B illustrate the through hole 50 for connecting two layers, that is, a surface layer and the back layer, the circuit board unit 1a is not restricted to two layers but a multilayer board having at least three layers may be used.

The through hole 50 is usually hollow. In the same manner as the function of the penetrating hole 30 according to the first embodiment, therefore, the through hole 50 is formed close to first and second electrodes 4 and 5 to obtain the function of absorbing the oscillation of the ceramic capacitor 2. In other words, the through hole 50 according to the second embodiment fulfills both functions of the absorption of the oscillation of the ceramic capacitor 2 and the connection of an electric signal.

### Other Embodiments

The shapes, the number and arrangement of the penetrating holes 30 and the through holes 50 are not restricted to the configurations illustrated in FIGS. 1A and 3A. Various other configurations can be taken.

FIG. 4 is an exemplary view showing a configuration of a circuit board unit 1b according to a third embodiment. According to the third embodiment, each of the first and second electrodes 4 and 5 is surrounded by three penetrating holes 30a having a slit shape arranged in a U-shape, respectively.

Attention will be paid to only the function of absorbing the oscillation of the first and second electrodes 4 and 5. As compared with the configuration according to the first and second embodiments, in which the small hole having the circular shape (the penetrating hole 30) is arranged rectilinearly, a higher oscillation absorbing effect can be obtained in the configuration according to the third embodiment. When the penetrating hole 30a having the slit shape is constituted as a penetrating hole, however, an area of an inside of the hole having the slit shape is reduced more greatly than that in a configuration in which the small holes having the circular shape are arranged rectilinearly. Therefore, an electrical resistance value is usually increased.

Accordingly, in order to determine the shape of the through hole, it is necessary to take both the electrical performance and the oscillation absorbing effect into consideration.

For the configuration of the hole, it may be also possible to combine the array of the small holes having the circular shape and the hole having the slit shape.

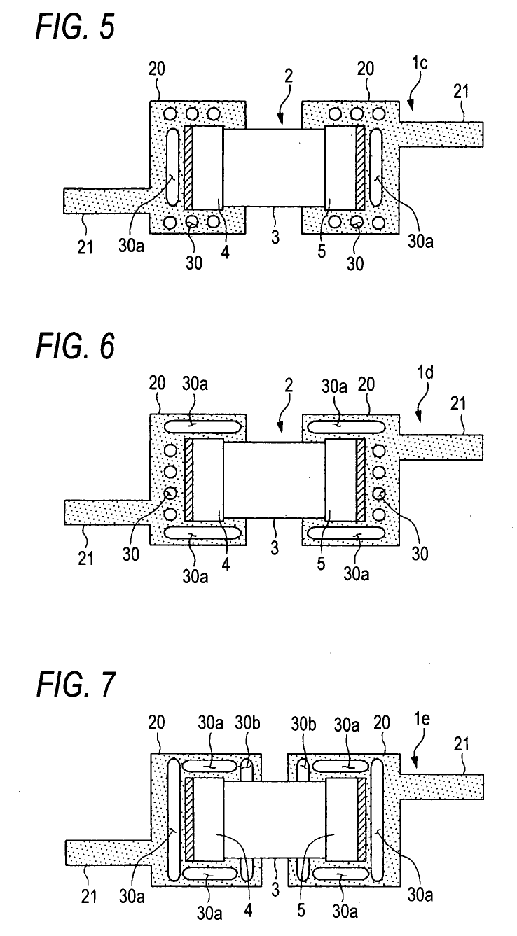

FIG. 5 is an exemplary view showing a configuration of a circuit board unit 1c according to a fourth embodiment. According to the forth embodiment, a penetrating hole 30a having the slit shape is formed in a longitudinal direction of the ceramic capacitor 2 and small holes each having a circular shape (a penetrating hole 30) are arranged in a lateral direction of the ceramic capacitor 2.

Moreover, FIG. 6 is an exemplary view showing a configuration of a circuit board unit id according to a fifth embodiment. According to the fifth embodiment, small holes each having a circular shape (a penetrating hole 30) are arranged in a longitudinal direction of the ceramic capacitor 2 and a penetrating hole 30a having the slit shape is formed in a lateral direction of the ceramic capacitor 2.

Thus, it may be also possible to properly select and combine the shapes, number and arrangement of the penetrating holes 30 and through holes 50.

FIG. 7 is an exemplary view showing a configuration of a circuit board unit 1e according to a sixth embodiment. According to the sixth embodiment, each of the first and second electrodes 4 and 5 of the ceramic capacitor 2 is surrounded by penetrating holes 30a and 30b having a slit shape in all four directions, respectively.

In the case in which a physical size of the ceramic capacitor 2 is comparatively large and there is a margin for forming a hole under the capacitor body 3, it may be also possible to form the penetrating hole 30b under the capacitor body 3 and to surround the first and second electrodes 4 and 5 by the penetrating holes in all four directions as illustrated in FIG. 7. In the configuration, the first and second electrodes 4 and 5 are surrounded by the penetrating holes in all four directions so that the effect for absorbing the oscillation of the ceramic capacitor 2 can be further enhanced. In addition, an aerial vibration around the capacitor body 3 can also be taken away downward from the circuit board unit 1 via the penetrating hole 30b. Therefore, it is possible to enhance the effect for preventing the resonance sound.

Usually, the oscillation of the ceramic capacitor 2 becomes greater when a capacity of the ceramic capacitor 2 is increased. However, a physical size of the ceramic capacitor 2 also becomes larger when the capacity of the ceramic capacitor 2 is increased. Thus, the first and second electrodes 4 and 5 are surrounded by the penetrating holes in all four directions according to the sixth embodiment may be effective.

Also in the sixth embodiment, an array of small holes having the circular shape may be used in stead, and they may be used with combining with penetrating hole having the slit shape.

As described above, according to the circuit board unit 1 etc. according to the embodiments, it may be possible to reduce an unnecessary resonance sound with an ordinary ceramic capacitor having no special additional member such as a metal plate.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A circuit board unit comprising:
a circuit board; and
an electronic component that is surface-mounted on the circuit board, the electronic component including a first electrode at one end and a second electrode at another end of the electronic component,
wherein the circuit board includes a plurality of penetrating holes penetrating through the circuit board at a position close to the first electrode and at a position close to the second electrode, the penetrating holes being arranged substantially symmetrically with respect to the electronic component.

2. The circuit board unit according to claim 1, wherein the electronic component includes a ceramic capacitor.

3. The circuit board unit according to claim 1, wherein the plurality of penetrating holes are arranged to surround each of the first and second electrodes.

4. The circuit board unit according to claim 3, wherein the plurality of penetrating holes are arranged in U-shape to surround each of the first and second electrodes, respectively.

5. The circuit board unit according to claim 1, wherein one of the penetrating holes has a substantially circular shape.

6. The circuit board unit according to claim 1, wherein one of the penetrating holes has a slit shape.

7. The circuit board unit according to claim 1, wherein the one of the penetrating holes has a substantially circular shape and another of the penetrating holes has a slit shape.

8. The circuit board unit according to claim 1, wherein the circuit board includes a plurality of layers, and
each of the penetrating holes is a through hole electrically connecting the layers to one another.

9. A circuit board unit comprising:
an electronic apparatus including first electrode at a first end thereof and a second electrode at a second end opposing to the first end; and
a circuit board mounting the electronic apparatus with the first and second electrodes being jointed at a first and second positions of the circuit board, respectively,
wherein the circuit board includes a plurality of penetrating hole penetrating through the circuit board close to the first and second positions, respectively.
